(19) United States
(12) Patent Application Publication
(10) Pub. No.: US 2014/0172189 A1
(43) Pub. Date: Jun. 19, 2014

(54) METHOD AND CONTROL DEVICE FOR PROVIDING A COURSE OF A ROAD AHEAD

(71) Applicant: Audi AG, Ingolstadt (DE)

(72) Inventor: Sebastian Engel, Ingolstadt (DE)

(73) Assignee: Audi AG, Ingolstadt (DE)

(21) Appl. No.: 14/095,282

(22) Filed: Dec. 3, 2013

(30) Foreign Application Priority Data
Dec. 19, 2012 (DE) 10 2012 024 873.3

(51) Int. Cl. G01C 21/34

(52) U.S. Cl. CPC G01C 21/34
USPC 701/1; 701/410; 701/430

(57) ABSTRACT

In a method for providing to a driver assistance system of a vehicle a course of a road ahead in relation to a geographical position and a direction of travel of the vehicle using the road, the geographical position is determined and the direction of travel is detected. Environmental data in the form of aerial image data are retrieved in relation to an aerial image of a predetermined area around the vehicle. The environmental data is evaluated for identifying road data of the used road from the aerial image data, and the vehicle is associated with the road. The position of the vehicle is determined relative to the road, and the course of the road is determined from the road data.

### CROSS-REFERENCES TO RELATED APPLICATIONS

This application claims the priority of German Patent Application, Serial No. 10 2012 024 873.3, filed Dec. 19, 2012, pursuant to 35 U.S.C. 119(a)-(d), the content of which is incorporated herein by reference in its entirety as if fully set forth herein.

### BACKGROUND OF THE INVENTION

The invention relates to a method for providing to a driver assistance system of a vehicle a course of a road ahead in relation to a geographical position and a direction of travel of the vehicle using the road. The invention also relates to a control device for carrying out the method.

The following discussion of related art is provided to assist the reader in understanding the advantages of the invention, and is not to be construed as an admission that this related art is prior art to this invention.

In the technical field of driver assistance systems, detection devices for detecting a course of a road ahead that are installed in vehicles are known which include for example a camera detecting lane markers. The information relating to the course of a road can be processed, for example, in conjunction with position data of the vehicle to represent the course of a road with reference to the current vehicle position, in particular in conjunction with electronic maps. For example, radar sensors or laser scanners can also be used in addition to camera devices, in particular for detecting reflector posts or guard rails.

A very accurate determination and to prediction of the course of a road is of interest, for example, for controlling of a device for lane assistance (so-called Lane Keeping Assistant, LKA) or for controlling a device for curve assistance, so that the lane can be maintained more accurately or an earlier or more reliable warning can be outputted when driving into a curve at an excessive speed, or for enabling a more forward-looking light control, for example, by automatically pivoting in curves or around bends.

However, the range of such detector devices is in many cases maximally 200 meters, wherein the detection devices can collect and evaluate information about the course of the road to only a limited extent when the road has bends or curves.

It would therefore be desirable and advantageous to obviate prior art shortcomings and to provide a device and a method for most accurate road recognition so as to predetermine a course of the road ahead with good accuracy based on generated road data. This should also enable improved control of a vehicle, in particular also with regard to vehicle safety.

### SUMMARY OF THE INVENTION

According to one aspect of the invention, a method for providing a course of a road ahead in relation to a geographical position and a direction of travel of a vehicle using the road to at least one driver assistance system of the vehicle includes the steps of:
a) determining the geographical position of the vehicle and detecting the direction of travel of the vehicle;
b) retrieving environmental data in a predetermined area around the vehicle position, in particular from a memory unit of the vehicle, and in particular in an area based on the direction of travel of the vehicle;
c) evaluating the environmental data for detecting road data at least of the used road in the area, and associating the vehicle with the road, in particular by using a control device;
d) determining the position of the vehicle relative to the road by combining the road data with the vehicle position, in particular by using the control device;
e) determining the course of the road from the road data in relation to the direction of travel, and
f) providing the course of the road and the vehicle position to the driver assistance system; as well as
at step b): retrieving the environmental data in the form of aerial image data in relation to an aerial image of the predetermined area, especially into the control device; and
at step c), extracting the road data, and in particular lane data of a single lane on the road, from the aerial image data.

According to one embodiment of the method, at step e) only those road segments are evaluated to determine the course of the road, that are driven by the vehicle according to a predetermined route within the next few seconds or minutes.

The present invention is thus based on the observation that aerial image data may be used to evaluate the course of the road even in a large range, particularly in a most accurate way and in a most predictive manner, without the need to resort to a separate road database. The course of the road may be determined with sufficient accuracy from the aerial image data themselves and, optionally, even at a great distance ahead of the vehicle.

According to another advantageous feature of the present invention, the vehicle may hereby be positioned with respect to the road data obtained from the aerial images relative to road edges on the road or, for example, with respect to tight bends. Thus, a data base may be provided to a driver assistance system, indicating whether a vehicle is in a dangerous situation, especially in view of the expected course of the road, i.e. underpasses, construction sites, bridges, curves, or the like. Due to the theoretically unlimited predictive range of the aerial image data, such a dangerous situation may also be predicted with sufficient lead time, which is advantageous especially at high speeds in excess of 150, 200 or even 225 km/h.

The aerial image data are hereby advantageously not approximated or simplified by geometric standard contours, but are initially present as (raw) image data that may be evaluated in the same form in which the data were collected. They may hence also have a high relevance. The course of the road may be evaluated independently by a detection unit (camera) of the vehicle or the road database of a navigation system, i.e. solely based on aerial images from which the course of the road is determined and into which the position of the vehicle is projected or computed. Only a single base for the data is required. A road geometry or the course of any lane boundary line thus does not have to be captured by the vehicle's onboard optical sensing means, but may be calculated solely based on the aerial image data, which may also be done with a freely selectable range in relation to that the route to be traveled by the vehicle. When determining the course based on aerial image data, the technical complexity of devices in the vehicles may be reduced since a complicated or technically particularly sophisticated environmental detection unit is not required, thereby also reducing the cost of a driver assistance system.

On the one hand, as described above, a very high accuracy may be attained by using (raw) image data; on the other hand, the amount of data to be kept relatively slim or small: the position of the vehicle is known via GPS, so that the road data at step c) may be extracted specifically for the used road, in particular at a certain distance in front and optionally also behind the vehicle, provided that a driver assistance system the rear area may also be considered. Thus, there no large database with a plurality (bad) approximated data for the course of the road is present, but rather an internal, small data base for the relevant road(s) that is generated based on demand. Here, the method may also be improved by evaluating (only) those road sections that are to be traveled in the next few seconds or minutes according to a predetermined route stored in a navigation device and then traveled by the vehicle. This allows the data set to be particularly small, thus minimizing the amount of computation.

By using the aforedescribed method, for example, an anticipatory curve light may be controlled in a highly accurate and predictive manner as a function of current retrieved aerial image data as well as aerial image data loaded into the vehicle or from the vehicle data and the road data determined therefrom. An anticipatory gear selection of an automatic transmission may also be the controlled. For example, detours or lane shifts, e.g. in construction areas, may also be taken into account.

In other words, the course of the road, especially of a lane of the road, may be reconstructed by generating road data from preferably raw, realistic (and optionally also particularly current) aerial image data. The aerial image data may, on the one hand, indeed be up to date and, on the other hand, be unchanged and not yet digitized and simplified by approximating the course of the road with geometric patterns (lines, circular arcs, clothoid spirals) in particular by an intermediate data server or a navigation system, i.e. reproduced in a simplified manner, which would degrade the accuracy. Approximation with geometric patterns (lines, circular arcs, clothoid spirals) is usually based on maps stored in navigation systems, in particular to reduce the amount of data. Small S-shaped curves are thereby potentially approximated by straight lines, or a transition from a straight line in a curve is only coarsely approximated, for example, with a uniform radius of curvature, although the curve is not circular. This degrades the accuracy, which does not make sense in conjunction with a driver assistance system, meaning it would degrade the function of the driver assistance system.

In accordance with an advantageous embodiment of the method that uses edge detection or other extraction methods from road data generated from aerial image data, the course may be predicted with high accuracy and for a large range, especially regardless of the presence of curve sections that cannot be detected optically or of road sections that are concealed by hills or other road bends. These road segments are also included in the aerial image and edge detection may also be performed for these non road sections that cannot be detected from the position of the vehicle or are imperceptible from the perspective of a vehicle occupant. A quite current picture of the road may also be obtained; for example a shifted construction site may be captured, in particular when the aerial image data are retrieved in real time and loaded into the vehicle. However, the aerial image data may also be retrieved at predeterminable times and the process may be carried out independent of a communication with a data server. Instead, the aerial image data or the data for the course of the road may be obtained from previously captured and already stored aerial image data. The analysis is therefore possible even without maintaining a continuously communication interface.

Determining the position and capturing at step a) of the method according to the invention may advantageously be carried out by retrieving geographical real-time position data for the position of the vehicle or by detecting data relating to the direction of travel of the vehicle.

At step b) and d) of the process according to the invention, the aerial image data may advantageously be combined with the position of the vehicle to determine the position of the vehicle in the aerial image, in particular by using the control device.

At step c), the extraction may advantageously be carried out in the aerial image using edge detection by generating edge data relating to the road, in particular as a function of a scaling factor of the aerial image, which contains information on the scale of the aerial image and/or the height from which the aerial image is generated. At step e), the edge data may then be evaluated, in particular by using the control device.

At step f), road data with information about a course of the lane used by the vehicle may be provided. For this purpose, the edge may advantageously be detected with respect to a single lane, in particular by evaluating lane boundary lines. The vehicle position may be provided relative to the road or the course of the road.

According to another advantageous feature of the present invention, the vehicle's onboard memory unit may be formed as a cache memory in which map data and environmental data are only temporarily stored, for example, when these data are retrieved in real time via an (Internet) connection; however, the memory unit may alternatively or additionally be configured as a type of hard disk, where the environmental data are permanently stored, thus making communication with an external vehicle-independent map database unnecessarily.

A scaling factor may be determined, for example, by the height from which the aerial image was created or the areal size of the image section with respect to the Earth's surface. The scaling factor in a particular aerial image is known and may be transmitted as image information with the aerial image itself. The scaling factor may be transmitted as part of the aerial image data without requiring a separate data connection or a separate signal. The scaling factor may be determined or evaluated by the controller directly from aerial image data.

Although it is advantageous, for example in view of the amount of data to be evaluated and the required computation time, to determine only a course of the road within an immediate area in front of the vehicle in the direction of travel, the immediate area may be arranged concentrically around the vehicle or elliptical, with the longer axis of the ellipse in the direction of travel, in order to provide to a driver assistance system also information relating to an area in the rear area of the vehicle, i.e. laterally and behind the vehicle. When the vehicle is stationary, that is does not move in a certain direction, the direction of travel may be defined by the longitudinal center axis of the vehicle, i.e. the position data may also be analyzed in the absence of changes over time, so that is known for a parked vehicle in which direction the front of the vehicle points for carrying out the method according to the invention with respect to the direction of travel.

Advantageously, an edge may be detected in relation to the road as such, in particular when the aerial image is captured from a substantial height, or in relation to individual lanes of the road, in particular when the aerial image is captured from a low height or the aerial image has a particularly high resolution. In this case, the edge data may be generated, for example, by identifying the road and the lateral boundaries of the road by way of color differences, for example shades of gray or shades of color, which allows also solid or dashed lane markers to be detected. Contours, shapes, or patterns may also be identified via predefined pattern to perform specific edge detection in these contours, shapes or patterns.

Real-time geographical position data of the vehicle may advantageously be retrieved by an on-board GPS system capable of receiving and analyzing GPS signals. Data relating to a direction of travel of the vehicle may be generated on the temporal course of the position data by received via the GPS signals. However, these data may also be determined by an on-board compass device which is able to output compass data and direction of travel data with respect to a central longitudinal axis of the vehicle.

The geographical real-time position data may be transmitted to the vehicle's onboard memory unit, and correlated with aerial image data previously stored in the memory unit or aerial image data retrieved only in response to the determination of the position.

At step e), in particular already from step d) on, only the extracted (edge) data need be processed. A driver assistance system must advantageously be supplied only with a small amount of data, i.e. data of the course of the road that are already filtered with respect to the significant information. The quantity of the extracted road data is then only a fraction of the quantity of aerial image data, thereby minimizing the computational effort and the computing time.

The detected course of the lane may be used for additional steps of the method, in particular the steps of:
g) retrieving vehicle status data for a driving condition of the vehicle, and
h) operating at least one function of the vehicle depending on the vehicle position and the course of the road and, and depending on the driving condition.
   These steps may be taken over by a driver assistance system, which may be configured as a subsystem of the vehicle system.

According to an advantageous embodiment, retrieving at step b) and extracting at step c) and/or evaluating at step e) takes place in a immediate area around the vehicle, in particular in the immediate area of 100 to 10,000, preferably 500 to 5000, particularly preferably 1000 meters around the vehicle, wherein the immediate area in the area at step b) is defined with respect to the aerial image data. Optionally, the immediate area may be defined in terms of the direction of travel and/or in relation to the course of the road, i.e. in a serpentine course of the road rectangular or even square laterally in relation to the vehicle, or for a highway extending substantially in a single direction elongated and in a line-shape along the highway in the direction of travel. This may reduce the amount of data to be processed.

According to an advantageous exemplary embodiment, the aerial image data are loaded into the vehicle from the memory unit and/or at least partially via a communication interface, in particular on-line from the Internet. Any database in which the preferably most current aerial image data are stored may be regarded as an online database accessible for loading the aerial image data. Preferably, the control device is configured for connection to several online databases, either simultaneously or sequentially, and to check in which online database aerial image data for the area of interest having greater timeliness and/or greater or better resolution (also more detailed aerial image data, in particular aerial image data with a smaller scaling factor, i.e. aerial image data recorded from a lower altitude) are stored, so as to retrieve those aerial image data having greater resolution or being more timely.

According to an advantageous embodiment, the aerial image data are loaded into the vehicle online from the Internet, wherein at step b), the aerial image for a immediate area in the direction of travel in front of the vehicle is loaded and the extraction at step c) is performed in the immediate area with respect to the direction of travel. This ensures that the road data are particularly current, and e.g. courses of roads shifted due to construction or newly created bridges may be taken into account.

According to an advantageous exemplary embodiment, portions of the aerial image, in which the course of the road is at least partially interrupted, are interpolated following the extraction at step c), especially before step e). This permits the compensation of any image interferences, artifacts, interim queues of cars that may be recorded in the aerial image data and may obscure the road boundaries, so that a contiguous street may still be determined. Preferably, the control device is configured to search for additional aerial image data, in particular aerial image data from an alternate database, for a road section requiring an interpolation, so as to be able to extract the road data with more certainty and to reconstruct the course of the road. Here, the course of the road may initially be established based on the interpolated data, wherein a comparison is performed when more precise aerial image data are found, whether the interpolation was carried out in a tolerance range; when the interpolated road data deviate too far from the more accurate aerial image data, the extraction process is performed in relation to the more accurate aerial image data and more accurate road data are provided.

According to an advantageous exemplary embodiment, the road data may be provided at step c) in relation to a pre-defined coordinate system having at least an x- and a y-direction, in particular a three-dimensional coordinate system, wherein a step size is defined at least in the x-and the y-direction. The accuracy may be defined by way of the step size in the x-and y-direction, with which the course of the road is evaluated in a particular direction of the coordinate system. When this is a very winding road which, however, extends substantially in a plane, for example a road in a road network of a Dutch town, there is no need for a small step size in the z-direction corresponding to a vertical direction. However, when this is a rather straight road extending over a number of hills, barriers, bridges, underpasses, a very small step size may be chosen in the z-direction, and the step size in the x-and y-direction may be increased, in particular to reduce the amount of data to be processed.

According to an advantageous exemplary embodiment, the course of the road and the position of the vehicle are evaluated by the control device or by a vehicle system coupled to the control device, and it is checked whether a function of the vehicle is to be controlled. In other words, the data may be provided such that the vehicle may be controlled by a driver assistance system.

According to an advantageous exemplary embodiment, a driving condition of the vehicle is detected and evaluated, wherein the vehicle is checked and controlled depending on the driving condition. For example, a reaction to a particularly high speed of the vehicle may be generated and a warning message may be outputted or the speed may already be reduced.

According to another aspect of the invention, a control device for providing a course of the road ahead in relation to a geographical position and a direction of travel of a vehicle using the road to at least one driver assistance system of the vehicle is configured to:
determine the geographical position of the vehicle and detect the direction of travel of the vehicle;
retrieve environmental data in a predeterminable area around the vehicle position, in particular from a memory unit of the vehicle, and in particular in an area relating to direction of travel of the vehicle;
evaluate the environmental data for identifying road data at least of the used road in the area, and assign of the vehicle to the road;
determine the vehicle position in relation to the road by combining the road data with the vehicle position;
determine the course of the road from the road data with respect to the direction of travel; and
provide the course of the road and the vehicle position to the driver assistance system;
wherein the control device is further configured to:
retrieve the environmental data in the form of aerial image data for an aerial image of the predeterminable area, and
extract from the aerial image data the road data, in particular lane data of a single lane on the road, and wherein
the control device is configured so as to evaluate, for providing the course of the road, only those road sections that are traveled by the vehicle in accordance with a predetermined route within the next few seconds or minutes.

By using such a control device, road data can be supplied to a driver assistance system with high accuracy, and the vehicle can be controlled with foresight and with sufficient time-buffered warning options for the driver, and can optionally also be controlled by intervening in the driving dynamics.

Preferably, the control device is configured to combine the aerial image data with the position of the vehicle for determining the vehicle position in the aerial image, and to extract the road data by way of edge detection in the aerial image by generating edge data for the road, in particular as a function of a scaling factor of the aerial image, which includes information about the scale of the aerial image and/or the height from which the aerial image is created.

The embodiments presented with reference to the method of the invention and their advantages apply, mutatis mutandis, also to the claimed control device.

The features and feature combinations mentioned above in the description and the features and feature combinations mentioned below in the description of the drawings or shown alone in the figures can not only be used in the particular combination, but also in other combinations or in isolation, without departing from the scope of the invention.

Other features and advantages of the present invention will be more readily apparent upon reading the following description of currently preferred exemplified embodiments of the invention with reference to the accompanying drawing, in which:

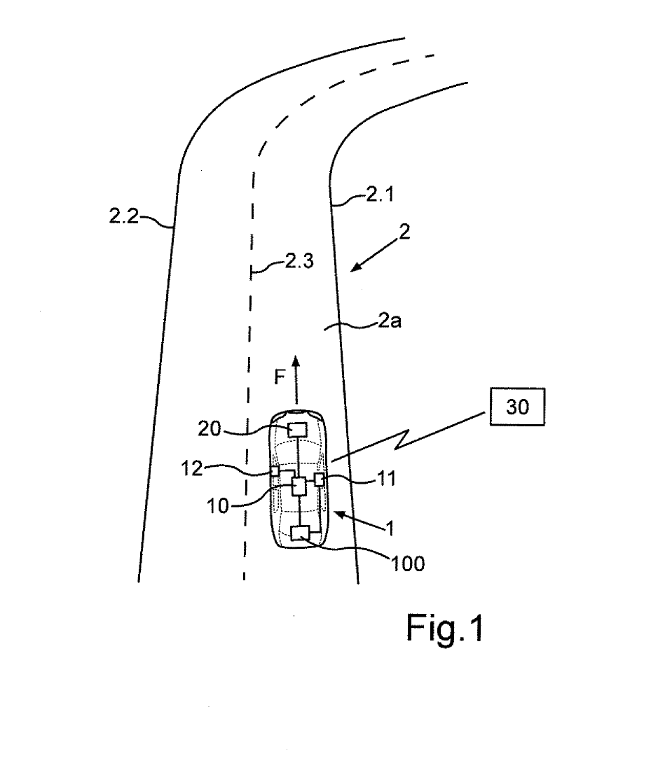

FIG. 1 a perspective view of an aerial image of a road with two lanes on which a vehicle is arranged, which is in communication with a data server, from which the vehicle retrieves aerial image data; and

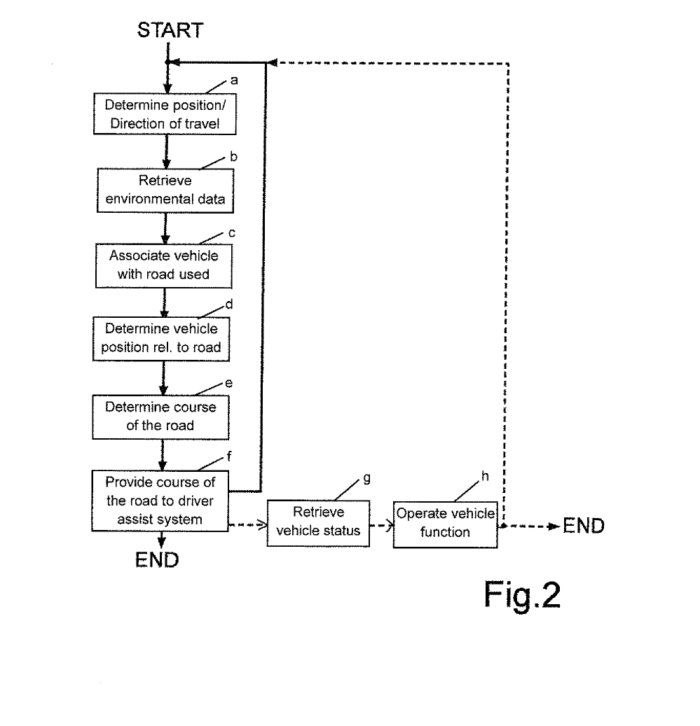

FIG. 2 a schematic diagram of a process flow of a method for determining the course of a road ahead in accordance with an exemplary embodiment of the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a vehicle 1 which drives in a driving direction F in the right lane 2a of a road 2. The vehicle 1 has a control device 10, wherein the vehicle 1 is in communication via the control device 10 or via a separate communication device with a data server 30, from which the vehicle 1 can receive or retrieves the aerial image data relating to the environment of the vehicle. The aerial image data can optionally also be stored at least partially in the vehicle 1, either from the outset or temporarily by caching the retrieved aerial image data, in particular to prevent a system failure caused by a temporary disruption of the communication, such as a loss of wireless coverage. For this purpose, the control device 10 is coupled to a memory device 12. The vehicle 1 further includes a position detection device 20, such as a GPS device, coupled to the controller 10 for capturing the position data of the vehicle. The control device 10 is configured to detect the direction of travel F, for example based on the temporal course of the position data, or based on a measured value provided by an unillustrated sensor device of the vehicle 1. A vehicle speed can also be taken into account in this manner by the control device 10. The control device 10 is coupled with at least one coupled actuator 11 and is configured to control the actuator 11, in particular to adjust a function such as curve light or a speed warning of the vehicle 1. The control device 10 is furthermore coupled with a vehicle system 100, in particular a navigation system. The vehicle system 100 is configured as a driver assistance system, or includes a separate driver assistance system, which allows an intervention in the vehicle dynamics depending on the provided course of the road.

The aerial image data received from the data server 30 thereby form basic data for evaluating the environment of the vehicle 1 and for detecting the course of the road 2. The control device 10 is configured to extract the road data from the aerial image by performing edge detection in the aerial image, in particular in relation to road boundaries 2.1, 2.2 and/or lane markers 2.3. The lane markers 2.3 may also be available, for example, in the form of a clearly perceptible guard rail that is visible in an aerial image, which exactly defines the course of the road, and which is provided, for example, in the middle between the two directions of travel on a motorway, as is realized on many Italian motorways.

FIG. 2 depicts the process flow of a method for determining a course of a road ahead as a function of a position of a vehicle using the road, with the steps of:
a) determining the geographical position of the vehicle and detecting the direction of travel of the vehicle;
b) retrieving environmental data in a predetermined area around the vehicle position, in particular from a memory unit of the vehicle, and in particular with respect to the direction of travel of the vehicle, wherein the environmental data in the form of aerial image data relating to an aerial image of the road are loaded into the control device, and the vehicle position in the aerial image is determined with the control device;
c) evaluating the environmental data for detecting road data in the area and at least the road, and associating the vehicle with the road, in particular with a control device, wherein the road data, and in particular lane data for a single lane on the road, are extracted from the aerial image preferably using edge detection in the aerial image and by generating with the control device edge data for the road as a function of a scaling factor of the aerial image, which contains information about the size of the aerial image and/or the height, from which the aerial image is generated;
d) determining the vehicle position relative to the road by combining the road data with the vehicle position, in particular by using the control device;
e) determining the course of the road from the road data in relation to the direction of travel, wherein the edge data are preferably evaluated by the control device; and
f) providing the course of the road ahead and the vehicle position to the driver assistance system.

The detected course of the road may be used for additional steps of the method, especially the steps of:
g) retrieving driving status data relating to a driving condition of the vehicle; and
h) operating at least one function of the vehicle depending on the vehicle position and the course of the road and depending on the driving condition. For example, a warning to the driver can be then generated indicating that his vehicle drives too fast for negotiating an upcoming curve.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of providing to at least one driver assistance system of a vehicle a course of a road ahead in relation to a geographical position and a direction of travel of the vehicle using the road, the method comprising the steps of:
a) determining the geographical position of the vehicle and detecting the direction of travel of the vehicle;
b) retrieving environmental data in a predetermined area around the position of the vehicle in form of aerial image data relating to an aerial image of the predetermined area;
c) evaluating the environmental data for detecting road data at least of the used road in the predetermined area, and extracting the road data from the aerial image data and associating the vehicle with the road;
d) determining the position of the vehicle relative to the road by combining the road data with the position of the vehicle;
e) determining the course of the road by evaluating the road data only from road sections that are to be driven by the vehicle in relation to the direction of travel according to a predetermined route within the next few seconds or minutes, and
f) providing the course of the road and the position of the vehicle to the driver assistance system.

2. The method of claim 1, wherein the steps of retrieving at step b) and extracting at step c) or determining at step e) take place in an immediate area around the vehicle, wherein the immediate area is defined at step b) inside the predetermined area with respect to the aerial image data.

3. The method of claim 2, wherein the immediate area is located 100 to 10,000 around the vehicle.

4. The method of claim 2, wherein the immediate area is located 500 to 5000 around the vehicle.

5. The method of claim 2, wherein the immediate area is located 1000 meters around the vehicle.

6. The method of claim 1, wherein the aerial image data are loaded into the vehicle from a memory unit of the vehicle.

7. The method of claim 1, wherein the aerial image data are loaded at least partially via a communication interface.

8. The method of claim 7, wherein the aerial image data are loaded on-line from the Internet.

9. The method of claim 2, further comprising:
loading the aerial image data on-line from the Internet,
loading the aerial image data at step b) for the immediate area in the direction of travel ahead of the vehicle, and
extracting the aerial image data at step c) in the immediate area with respect to the direction of travel.

10. The method of claim 1, further comprising, subsequent to extracting in step c) and prior to step e), interpolating portions of the aerial image where the road is at least partially interrupted.

11. The method of claim 1, wherein the road data at step c) are provided with respect to a predefined coordinate system having at least an x-direction and a y-direction with a defined step size at least in the x-direction and in the y-direction.

12. The method of claim 11, wherein the predefined coordinate system is a three-dimensional coordinate system.

13. The method of claim 1, further comprising evaluating the course of the road and the position of the vehicle with a control device or with a vehicle system coupled with the control device, and checking whether a function of the vehicle requires controlling.

14. The method of claim 13, further comprising detecting and evaluating a driving condition of the vehicle, and checking and controlling the function of the vehicle depending on the driving condition.

15. A control device for providing to at least one driver assistance system of a vehicle a course of a road ahead in relation to a geographical position and a direction of travel of the vehicle using the road of the vehicle, which control device is configured to:
determine the geographical position of the vehicle and detect the direction of travel;
retrieve environmental data in a predetermined area around the position of the vehicle;
evaluate the environmental data for detecting road data of at least the used road in the predetermined area, and associate the vehicle with the road;
determine the position of the vehicle relative to the road by combining of the road data with the position of the vehicle;
determine the course of the road from the road data in relation to the direction of travel only for road sections that are traveled by the vehicle in accordance with a predetermined route within the next few seconds or minutes;
provide the course of the road and the position of the vehicle to the driver assistance system;
retrieve the environmental data in the form of aerial image data in relation to an aerial image of the predetermined area,
extract the road data from the aerial image data.
